(19) United States
(12) Patent Application Publication
(10) Pub. No.: US 2011/0192465 A1
(43) Pub. Date: Aug. 11, 2011

(54) Vacuum Sewer Valve Fault Detection System

(75) Inventor: John K. Collings, III, Mableton, GA (US)

(73) Assignee: Mission Communications, LLC, Norcross, GA (US)

(21) Appl. No.: 12/702,393

(22) Filed: Feb. 9, 2010

(51) Int. Cl. F16K 37/00

(52) U.S. Cl. 137/1; 137/554

(57) ABSTRACT

A sensor unit detects an open vacuum interface valve coupled to a gravity sump that is pneumatically coupled to an air relief tube of a vacuum sewage system. The sensor unit includes an open valve sensor, a communication device, a processor and a power source. The open valve sensor is affixed to the air relief tube. The processor is in electronic communication with the open valve sensor and the communication device. The processor is configured to read a sensed value from the open valve sensor and cause the communication device to transmit an alarm signal when the sensed value meets predefined criteria. The power source provides power to the open valve sensor and to the communication device.

### BACKGROUND OF THE INVENTION

1. Field of the Invention

The present invention relates to valve sensor systems and, more specifically, to a sensor system for detecting faulty valves in a vacuum sewer system.

2. Description of the Prior Art

Vacuum sewer systems are commonly used in areas without a substantial natural gradient that allows gravity flow of sewage to a treatment plant. Such systems are often used in beachside and island residential areas because in such areas most houses are topographically nearly as low as or lower than the elevation of the sewage treatment plant.

In a vacuum sewer system, as shown in FIG. 1, sewage flows by gravity from a home 10 into a collection pit 20 (a single collection pit may connect several homes to a vacuum sewer system), that includes a sump 22. Located above the sump 22 is a vacuum interface valve 24 that is pneumatically controlled and operated. As the sewage level rises in the sump, air trapped in sensor pipe pushes on a diaphragm in a controller coupled to the vacuum interface valve 24, which causes the valve to open when the sewage reaches a predetermined level. When the vacuum interface valve 24 opens, differential air pressure between the collection pit 20 and a sewage main 30 propels the sewage through a suction tube 26 and through the valve 24 into the sewage main 30, which is kept under a vacuum. An air relief tube 40 is provided to allow air inflow into the collection pit 20 while the vacuum interface valve 24 is open.

The sewage flows through the sewage main 30 into a collection tank 52 at a vacuum station 50. Sewage pumps transfer the sewage from the collection tank 52 to the wastewater treatment facility or nearby gravity manhole. Differential air pressure is the driving force in vacuum sewer systems. Typically, vacuum sewer lines are kept under a vacuum of −50 kPa to −70 kPa created by the vacuum pump 52 located at the vacuum pump station 50. This pressure differential provides the energy required to open the vacuum interface valves and to transport the sewage.

For various reasons, a vacuum interface valve 24 can get stuck in an open, or partially open position. When this occurs, air can flow freely from the air relief tube 40 into the sewage main 30. This causes a loss of vacuum in the sewage main 30, which results in the vacuum pump 52 over working and wasting energy.

In a vacuum sewer system in which many different collection pits are serviced by a common sewage main, a stuck open valve is usually detected when the vacuum pump at the vacuum station cycles “on” an unusually high number of times during a given hour. Once a stuck valve is detected, a technician has to shut off each leg of the system along the main until the leaking valve is detected. This can be quite time consuming and costly, as it takes at least one hour to detect the existence of a faulty valve and it can take several hours to determine which valve on the line is faulty. It can also leave many homes on the line without sewer service while their systems are being shut down during the leak detection process.

It has been proposed to retrofit existing vacuum interface valves with underground electronic valve position detection switches. However, doing so would require digging to the valve level to install such switches and also would require installing electrical power systems and underground communication systems that are coupled the switches. Thus, installing such switches would be both difficult and costly.

Therefore, there is a need for a detection system for faulty vacuum interface valve that can quickly detect a faulty valve, but that can be installed without requiring access to the inside of a collection pit.

### SUMMARY OF THE INVENTION

The disadvantages of the prior art are overcome by the present invention which, in one aspect, is a sensor unit for detecting an open vacuum interface valve coupled to a gravity sump that is pneumatically coupled to an air relief tube of a vacuum sewage system. The sensor unit includes an open valve sensor, a communication device, a processor and a power source. The open valve sensor is in pneumatic communication with the interior of the air relief tube. The processor is in electronic communication with the open valve sensor and the communication device. The processor is configured to read a sensed value from the open valve sensor and cause the communication device to transmit an alarm signal when the sensed value meets predefined criteria. The power source provides power to the open valve sensor and to the communication device.

In another aspect, the invention is a system for detecting an open vacuum interface valve coupled to a gravity sump of in a vacuum sewage system. The system includes a plurality of sensor units and at least one monitoring station. Each sensor unit of the plurality of sensor units includes at least one air relief tube pressure sensor coupled to an interior portion of the air relief tube, at least one ambient pressure sensor disposed outside of the air relief tube, a communication device and a processor in electronic communication with the air relief tube pressure sensor, the ambient pressure sensor and the communication device. The processor is configured to read a first pressure from the air relief tube pressure sensor and a second pressure from the ambient pressure sensor periodically, calculate a difference between the first pressure and the second pressure, cause the communication device to transmit an alarm signal to a network when the difference meets predefined criteria, a memory that stores identifying data that is uniquely associated with the sensor unit and wherein the alarm signal includes the identifying data and a power source for providing power to the air relief tube pressure sensor, the one ambient pressure sensor and the communication device. At least one monitoring station receives the alarm signal. The monitoring station includes a computer configured to correlate the identifying data with the sensor unit and to display an identification of which sensor unit that has detected an open vacuum interface valve.

In yet another aspect, the invention is a method for detecting an open vacuum interface valve coupled to a gravity sump coupled to a vacuum sewage system, in which a pressure drop is detected inside of an air relief tube coupled to the vacuum sewage system, in which the pressure drop is associated with the open vacuum interface valve. When the pressure drop is sustained for a predetermined amount of time, then a signal is transmitted to a monitoring station. The signal includes data that identifies the open interface valve.

These and other aspects of the invention will become apparent from the following description of the preferred embodiments taken in conjunction with the following drawings. As would be obvious to one skilled in the art, many variations and modifications of the invention may be effected without departing from the spirit and scope of the novel concepts of the disclosure.

### BRIEF DESCRIPTION OF THE FIGURES OF THE DRAWINGS

FIG. 1 is a schematic diagram of a prior art vacuum sewer system.

FIG. 2 is a schematic diagram of a sensor mesh of a valve fault detection system.

FIG. 3 is a schematic diagram of an air relief tube with a valve fault sensor affixed thereto.

FIG. 4 is a schematic diagram of a valve fault sensor.

FIG. 5A is a front elevational view of a valve fault sensor.

FIG. 5B is a side elevational view of the valve fault sensor shown in FIG. 5A.

FIG. 6 is a schematic diagram of a valve fault detection system.

FIG. 7 is a flow chart showing one representative method of operation of a valve fault sensor.

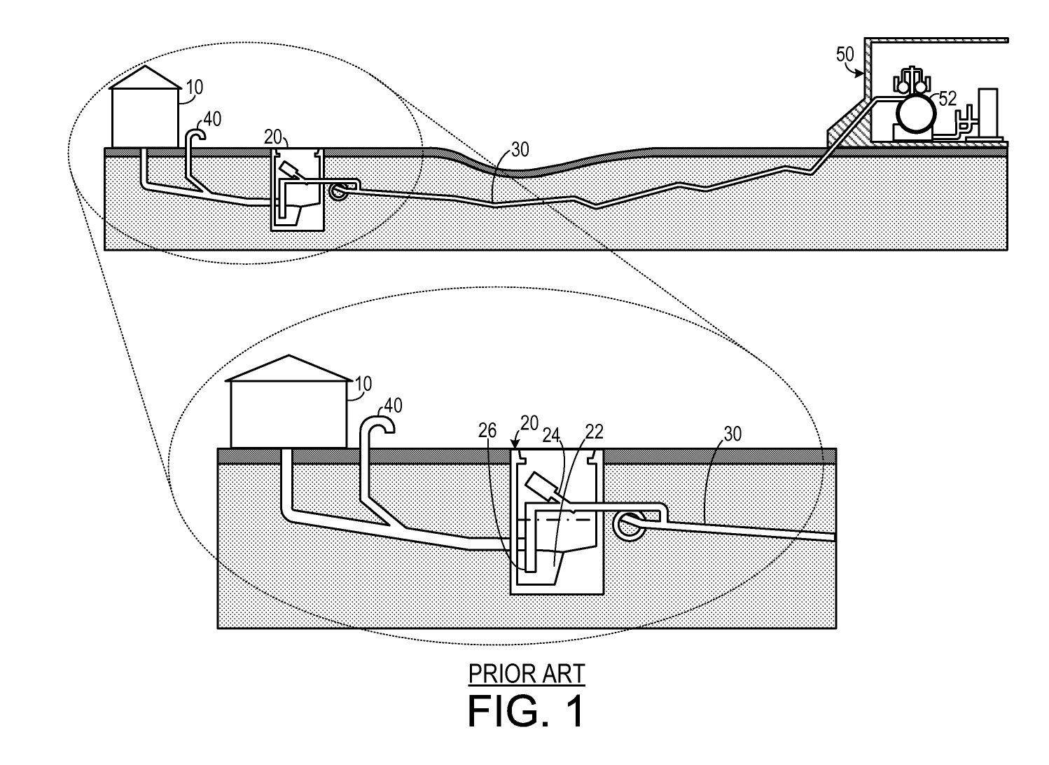

### DETAILED DESCRIPTION OF THE INVENTION

A preferred embodiment of the invention is now described in detail. Referring to the drawings, like numbers indicate like parts throughout the views. Unless otherwise specifically indicated in the disclosure that follows, the drawings are not necessarily drawn to scale. As used in the description herein and throughout the claims, the following terms take the meanings explicitly associated herein, unless the context clearly dictates otherwise: the meaning of “a,” “an,” and “the” includes plural reference, the meaning of “in” includes “in” and “on.” Also, as used herein, “global computer network” includes the Internet.

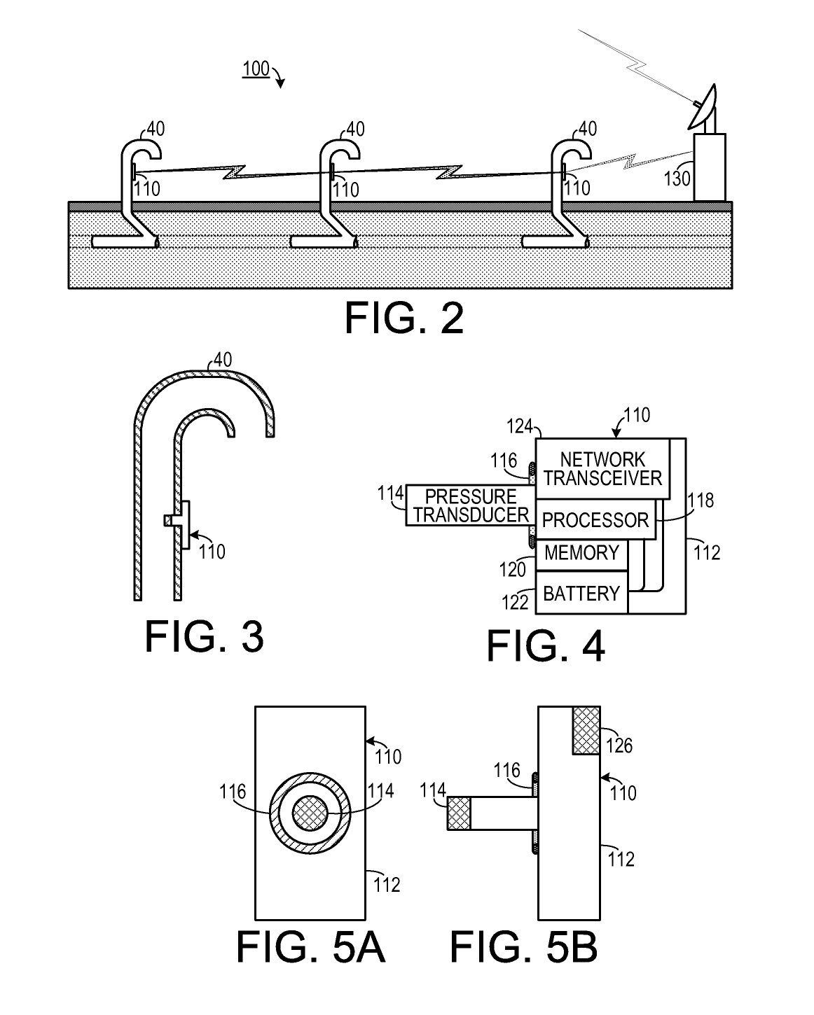

As shown in FIG. 2, one embodiment is a system 100 for detecting an open vacuum interface valve coupled to a gravity sump of in a vacuum sewage system. Each of a plurality of sensor units 110 is coupled to an above-ground portion of a different air relief tube 40 in the vacuum sewage system. Each sensor unit 110 is configured to detect when a vacuum interface valve is stuck open. Each sensor unit 110 is configured to communicate data regarding the current state of the air relief valve associated with its air relief tube 40 to a relay station 130 or a central monitoring station.

Detection may occur in one of several ways. For example, as shown in FIG. 3, in one embodiment a sensor unit 110 is configured to detect a pressure differential between the inside of a relief tube and the ambient pressure. When the inside of the relief tube has a sustained lower pressure than ambient pressure for a predetermined period, the pressure sensor (or the central monitoring station receiving data from the sensor unit 110) determines that the valve is stuck open. In another embodiment, the sensor detects sound inside of the relief tube and if the sound inside of the tube corresponds to the sound made by an open valve for a predetermined amount of time, the system determines that the valve is stuck open.

Returning to FIG. 2, in one representative embodiment each sensor unit 110 includes a wireless communications device that allows it to communicate automatically with a relay station 130. When the relay station receives data from a sensor unit 110, it transmits the data to a central monitoring station for further processing.

As shown in FIGS. 4, 5A and 5B, a sensing unit 110 configured to sense pressure can include several components, including a pressure transducer 114 that is couplable to the inside of an air relief tube 40 to determine an internal air pressure. This may be done either by placing the pressure transducer through a hole drilled in the air relief tube 40, or by coupling an external pressure sensor to a tube that is in communication with the interior of the air relief tube 40.

A processor 118 receives the internal air pressure from the pressure transducer 114 determines if a pressure drop that is characteristic of a stuck open valve has occurred. In another embodiment, the processor merely collects the pressure data and transmits it to the central monitoring station where the determination of whether the valve is stuck open is made. If a sufficient pressure drop is sensed, the processor 118 determines if the pressure drop lasts for a period of time that would indicate that the valve is stuck open (i.e., when the pressure drop is sustained for longer that the pressure drop expected from a normal emptying of the sump). A memory 120 stores the data from the pressure transducer and a unique identification of the sensor (which can be used to identify the location of the stuck open valve by pairing the unique identifications of all sensors with locations in a sump location database), along with any necessary program data. In an alternative embodiment, the sensing unit could include a microphone configured to sense sound inside of the air relief tube and a signal processor to determine if the sound corresponds to the sound made by a stuck open valve.

An ambient pressure transducer 126 (as shown in FIG. 5B) can be added in one embodiment to determine the ambient air pressure outside of the air relief tube. In this embodiment, a differential between pressure transducer 114 and pressure transducer 126, can be used to determine if the valve is stuck open. This embodiment would be more expensive to produce; however, it would compensate for sudden changes in ambient pressure.

A communications device, such as a mesh network transceiver 124 (e.g., a Zigbee® mesh network transceiver) or a networking radio, transmits data from the sensor unit 110 to the central monitoring station. If a mesh network transceiver 124 is used, then the sensor units 110 work together to form a mesh network, which can cover a wide distance, yet expend relatively little power. A power source, such as a battery 122 (e.g., a lithium ion battery) or a solar power cell, powers the transducers, the processor and the communications device. The sensing unit 110 may be placed in a protective housing 112 with a gasket 116 used to prevent air leakage into the air relief tube when in use.

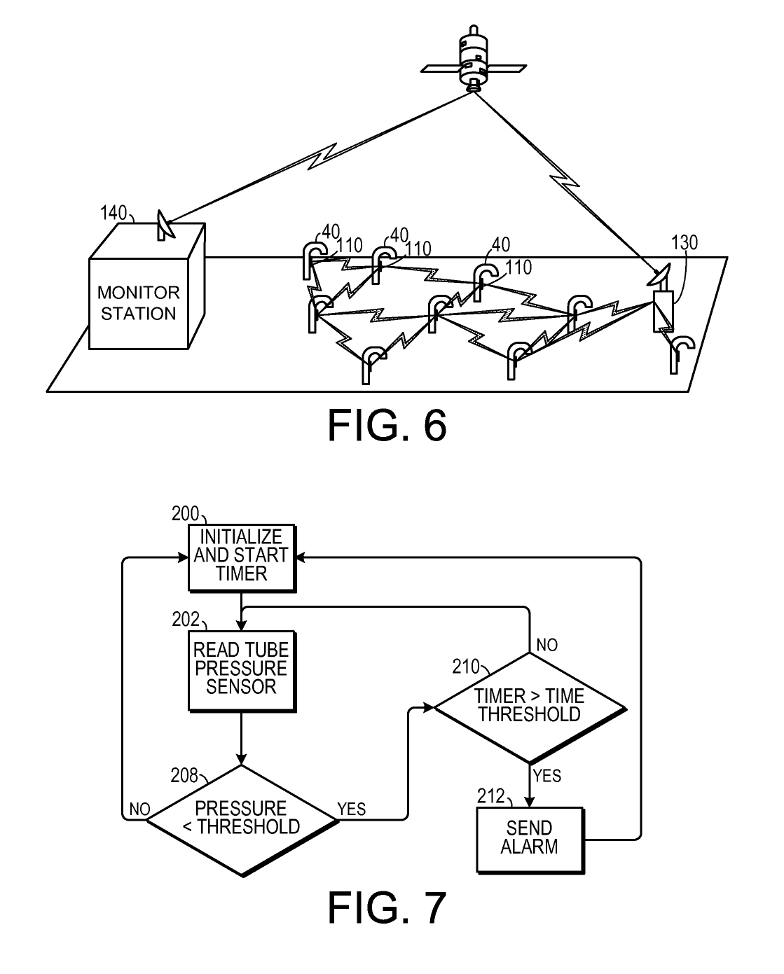

As shown in FIG. 6, the individual sensing units 110 can form a mesh network that eventually communicates with a relay station 130. Alternately, a network of radio repeater hubs can be employed to form a network. The relay station 130 communicates data received from the network to a central monitoring station 140. This may be done in several ways, including transmission via a wireless network, transmission via a satellite communication system, transmission via land lines, transmission via a global computer network, or one of the many other ways of transmitting data between stations.

As shown in FIG. 7, in one method of determining whether to send an alarm corresponding to a stuck open valve, a timer is started 200, the pressure inside of the air relief tube is sensed 202. A test 208 is performed to determine if the pressure is less than a predetermined threshold corresponding to the pressure that would exist when the valve is open. If the pressure is less than the threshold, then the current value of the timer is compared 210 to a time threshold to determine if the valve has been open continuously for an amount of time that would indicate that the valve is stuck open. If the result is that the valve is stuck open, then an alarm is issued 212. The alarm, which identifies the stuck open valve, may be displayed on an alarm screen, sent directly to a technician, or both. The alarm would be coupled with a display indicating which valve was stuck open, thereby allowing a technician to identify the stuck open valve easily.

While the sensed data may be evaluated locally by the processor, it may also be transmitted to the central monitoring station to be evaluated there. In this case, the sensed data, a timestamp and a sensor unit are all transmitted to the central monitoring station. The central monitoring station could periodically poll each of the sensor units, or the sensor units could be programmed to upload the data to the central monitoring station on a periodic basis. It is also possible that both a central monitoring station evaluation and a local evaluation are performed to increase reliability of the system.

A similar method could be employed if another quality of the air relief tube is being sensed to determine if the valve is stuck open. For example, if a sound sensor is being used, the system could compare the sound being sensed to a characteristic of the sound that would be expected if the valve were stuck open. In such a system, the sensed sound could be transformed (using well known signal processing techniques, such as with a digital signal processor) into a frequency domain representation and this representation can be compared to a frequency domain representation of the sound made by an open valve. If the representations are the same, or within a predetermined margin of each other, for a period of time that would indicate that the valve is stuck open, then an alarm will be issued. The sound sensor could also be configured to detect a higher sound volume than normal (or a higher volume than normal of certain frequency components of the sound in the air relief tube).

The above described embodiments, while including the preferred embodiment and the best mode of the invention known to the inventor at the time of filing, are given as illustrative examples only. It will be readily appreciated that many deviations may be made from the specific embodiments disclosed in this specification without departing from the spirit and scope of the invention. Accordingly, the scope of the invention is to be determined by the claims below rather than being limited to the specifically described embodiments above.

What is claimed is:

1. A sensor unit for detecting an open vacuum interface valve coupled to a gravity sump that is pneumatically coupled to an air relief tube of a vacuum sewage system, comprising:
a. an open valve sensor configured to sense a property inside of the air relief tube;
b. a communication device;
c. a processor in electronic communication with the open valve sensor and the communication device, the processor configured to:
i. read a sensed value from the open valve sensor; and
ii. cause the communication device to transmit a signal when the sensed value meets predefined criteria; and
d. a power source for providing power to the open valve sensor and to the communication device.

2. The sensor unit of claim 1, wherein the communication device comprises a mesh network communication device configured to communicate with a mesh network.

3. The sensor unit of claim 1, wherein the communication device comprises a networking radio.

4. The sensor unit of claim 1, wherein the signal transmitted from the communication device comprises an alarm signal.

5. The sensor unit of claim 1, wherein the signal transmitted from the communication device comprises data received from the open valve sensor and a time stamp.

6. The sensor unit of claim 1, further comprising a memory that stores identifying data that is uniquely associated with the processor and wherein the alarm signal includes the identifying data.

7. The sensor unit of claim 1, wherein the power source comprises a battery.

8. The sensor unit of claim 1, wherein the open valve sensor comprises at least one air relief tube pressure sensor in communication with an interior portion of the air relief tube, wherein the processor is further configured to read a first pressure from the air relief tube pressure sensor periodically.

9. The sensor unit of claim 8, wherein the predefined criteria are met when the first pressure is less than a predetermined threshold for a predetermined amount of time.

10. The sensor unit of claim 1, wherein the open valve sensor, the communication device and the processor are all disposed in a protective container, wherein a tubular coupling couples a portion of the open valve sensor to an interior portion of the air relief tube.

11. The sensor unit of claim 10, further comprising a gasket disposed about the open valve sensor, the gasket configured to seal the protective container to an external surface of the air relief tube when the open valve sensor is inserted through a hole in the air relief tube.

12. The sensor unit of claim 1, wherein the open valve sensor comprises a noise sensor and wherein the predetermined criteria are met when the noise sensor detects a predetermined noise for greater than a predetermined amount of time.

13. A system for detecting an open vacuum interface valve coupled to a gravity sump of in a vacuum sewage system, comprising:
a. a plurality of sensor units, each sensor unit including:
i. at least one air relief tube pressure sensor coupled to an interior portion of the air relief tube;
ii. a communication device;
iii. a processor in electronic communication with the air relief tube pressure sensor and the communication device, the processor configured to:
(1) read a first pressure from the air relief tube pressure sensor periodically; and
(2) cause the communication device to transmit an alarm signal to a network when the first pressure meets predefined criteria;
iv. a memory that stores identifying data that is uniquely associated with the sensor unit and wherein the alarm signal includes the identifying data; and
v. a power source for providing power to the air relief tube pressure sensor, the processor and the communication device; and
b. at least one monitoring station that receives the alarm signal, the monitoring station including a computer configured to correlate the identifying data with the sensor unit and to display an identification of which sensor unit that has detected an open vacuum interface valve.

14. The system of claim 13, further comprising a central relay station that is in data communication with the network, wherein the alarm signal is transmitted through the network to the central relay station and wherein the central relay station transmits the alarm signal to the monitoring station.

15. The system of claim 14, wherein the central relay station includes a wireless transmitter configured to transmit the alarm signal to the monitoring station.

16. The system of claim 13, wherein the predefined criteria are met when the first pressure is greater than a predetermined threshold for a predetermined amount of time.

17. The system of claim 13, wherein the communication device and the processor are all disposed in a protective container, the air relief tube pressure sensor extending outwardly therefrom.

18. The system of claim 17, further comprising a gasket disposed about the air relief tube pressure sensor the gasket configured to seal the protective container to an external surface of the air relief tube when the air relief tube pressure sensor is inserted through a hole in the air relief tube.

19. The system of claim 13, wherein the power source comprises a battery.

20. A method for detecting an open vacuum interface valve coupled to a gravity sump coupled to a vacuum sewage system, comprising the actions of:
a. detecting a pressure drop inside a passage in pneumatic communication with an air relief tube coupled to the vacuum sewage system and associated with the open vacuum interface valve;
b. when the pressure drop is sustained for a predetermined amount of time, then transmitting a signal to a monitoring station, the signal including data that identifies the open interface valve.

21. The method of claim 20, wherein the action of detecting a pressure drop comprises the actions of:
a. detecting a first pressure inside the air relief tube; and
b. determining when the difference is greater than a predetermined threshold.

22. The method of claim 20, further comprising the actions of:
a. correlating the data that identifies the open interface valve to a corresponding vacuum interface valve; and
b. displaying an indication that the corresponding vacuum interface valve is open.
